(19) United States
(12) Patent Application Publication
(10) Pub. No.: US 2011/0080545 A1
(43) Pub. Date: Apr. 7, 2011

(54) REFLECTION TYPE OPTICAL MODULATION DEVICE

(75) Inventor: Yasushi Ohbayashi, Shizuoka (JP)

(73) Assignee: HAMAMATSU PHOTONICS K.K., Hamamatsu-shi (JP)

(21) Appl. No.: 12/995,830

(22) PCT Filed: Jun. 19, 2008
(86) PCT No.: PCT/JP2008/061252

§ 371 Date: Dec. 2, 2010

(51) Int. Cl. G02F 1/1335

(52) U.S. Cl. 349/114

(57) ABSTRACT

A reflection type liquid crystal device (reflection type light modulation device) 1 includes a transparent conductive film 22 containing a conductive material which transmits light L; a plurality of metallic pixel electrodes 16 two-dimensionally arrayed along the transparent conductive film 22; a liquid crystal layer 20 which is disposed between the plurality of pixel electrodes 16 and the transparent conductive film 22, and modulates the light L according to an electric field formed by each pixel electrode 16 and the transparent conductive film 22; and a dielectric multilayer film 18 formed on the plurality of pixel electrodes 16. The dielectric multilayer film 18 includes a first layer in contact with the pixel electrodes 16, and a second layer having a refractive index higher than that of the first layer and being in contact with the first layer. Accordingly, a reflection type light modulation device including a dielectric multilayer film which can realize a high reflectance while suppressing lowering of efficiency of electric field application to the light modulation layer is realized.

### TECHNICAL FIELD

The present invention relates to a reflection type light modulation device.

BACKGROUND ART

As a reflection type light modulation device, a reflection type liquid crystal device (LCoS (registered trademark): Liquid crystal on silicon) is known. The reflection type liquid crystal device includes a plurality of pixel electrodes two-dimensionally arrayed, a conductive light transmitting layer, and a liquid crystal layer (light modulation layer) disposed between the plurality of pixel electrodes and the conductive light transmitting layer, and while reflecting the light made incident via the conductive light transmitting layer, forms an electric field between an arbitrary pixel electrode and the conductive light transmitting layer and generates modulation action on the liquid crystal layer to obtain a desired optical image. Moreover, in order to increase the light reflectance and obtain an optical image with higher intensity, a dielectric multilayer film is provided between the liquid crystal layer and the plurality of pixel electrodes.

For example, Non-Patent Documents 1 and 2 disclose liquid crystal light valves (LCLV) having a reflection type liquid crystal structure. The dielectric multilayer film described in Non-Patent Document 1 is formed by alternately laminating pluralities of Si layers and SiO₂ layers each having optical film thickness of λ/4 (λ: wavelength of incident light). And, the dielectric multilayer film described in Non-Patent Document 2 is formed by alternately laminating pluralities of TiO₂ layers and SiO₂ layers each having optical film thickness of λ/4. Non-Patent Document 1: U. Efron et al., “Silicon liquid crystal light valves: status and issues”, Optical Engineering, November, December 1983, Vol. 22, No. 6, pp. 682-686 (1983)
Non-Patent Document 2: A. Jacobson et al., “A real-time optical data processing device”, Information Display, Vol. 12, September 1975, PP. 17-22(1975)

### DISCLOSURE OF THE INVENTION

### Problem To Be Solved By the Invention

According to the knowledge of the inventor, in the conventional reflection type liquid crystal device, a dielectric multilayer film laminated on a surface of a glass substrate, etc., is used. Then, by increasing the number of lamination layers, a high reflectance over 99% is obtained. For example, in order to obtain a reflectance not less than 99% on the dielectric multilayer film on a glass substrate, 13 layers of TiO₂/SiO₂, 19 layers of HfO₂/SiO₂ are required, and in order to obtain a reflectance not less than 99.8%, 17 layers of TiO₂/SiO₂, 25 layers of HfO₂/SiO₂ are required.

However, the dielectric multilayer film is disposed between a liquid crystal layer and pixel electrodes, so that an electric field formed between the pixel electrodes and the conductive light transmitting layer is applied not only to the liquid crystal layer but also to the dielectric multilayer film. If the number of lamination layers of the dielectric multilayer film increases, the thickness (physical film thickness) of the dielectric multilayer film increases, and the ratio of the electric field to be applied to the dielectric multilayer film increases, so that the efficiency of electric field application to the liquid crystal layer is lowered.

The present invention has been made in view of the above-described problem, and an object thereof is to provide a reflection type light modulation device including a dielectric multilayer film which can realize a high reflectance while suppressing lowering of efficiency of electric field application to a light modulation layer.

### Means For Solving the Problem

In order to solve the above-described problem, a reflection type light modulation device of the present invention modulates light made incident from the front side in each of a plurality of pixels two-dimensionally arrayed and outputs an optical image forward while reflecting the light, including: a conductive light transmitting layer containing a conductive material which transmits light; a plurality of metallic pixel electrodes two-dimensionally arrayed along the conductive light transmitting layer; a light modulation layer which is disposed between the plurality of pixel electrodes and the conductive light transmitting layer, and modulates the light according to an electric field formed by each pixel electrode and the conductive light transmitting layer; and a dielectric multilayer film formed on the plurality of pixel electrodes, wherein the dielectric multilayer film includes a first layer in contact with the pixel electrodes and a second layer which has a refractive index higher than that of the first layer and is in contact with the first layer.

As described above, in a conventional general reflection type light modulation device, a dielectric multilayer film formed on a glass substrate is used. On the other hand, in the reflection type light modulation device according to the present invention, a dielectric multilayer film is formed on a plurality of metallic pixel electrodes. Accordingly, a high reflectance of the metal surface can be utilized. Moreover, the inventor found that, when the dielectric multilayer film is formed on a metal surface, a low refractive index layer (first layer) is formed first on the metal surface, and then a high refractive index layer (second layer) is laminated on the low refractive index layer, and accordingly, a sufficient reflectance can be obtained with a number of lamination layers much smaller than in the case where the high refractive index layer is laminated first. Therefore, in the above-described reflection type light modulation device, lowering of efficiency of electric field application to the light modulation layer can be suppressed by making the physical film thickness of the dielectric multilayer film thinner than conventionally, and a sufficiently high reflectance is realized and light extraction efficiency can be increased.

Alternatively, a reflection type light modulation device of the present invention modulates light made incident from the front side in each of a plurality of pixels two-dimensionally arrayed and outputs an optical image forward while reflecting the light, including: a conductive light transmitting layer containing a conductive material which transmits light; a plurality of metallic pixel electrodes two-dimensionally arrayed along the conductive light transmitting layer; a light modulation layer which is disposed between the plurality of pixel electrodes and the conductive light transmitting layer, and modulates the light according to an electric field formed by each pixel electrode and the conductive light transmitting layer; and a dielectric multilayer film formed on the plurality of pixel electrodes, wherein the dielectric multilayer film includes a third layer in contact with the pixel electrodes, a first layer which has a refractive index lower than that of the third layer and is in contact with the third layer, and a second layer which has a refractive index higher than that of the first layer and is in contact with the first layer, and the optical film thickness of the third layer is substantially equal to (λ/2)×n (n is an odd number) provided that λ is a wavelength of the light.

Even when the high refractive index layer (third layer) is thus formed on the metal surface, by making the optical film thickness of the third layer substantially equal to (λ/2)×n (n is an odd number), the influence on the reflectance can be made very small. Therefore, by forming a dielectric multilayer film including a low refractive index layer (first layer) laminated first on the third layer, substantially the same reflection characteristics as those of the aforementioned reflection type light modulation device can be realized.

### Effects of the Invention

According to a reflection type light modulation device of the present invention, light extraction efficiency can be increased while suppressing lowering of efficiency of electric field application to the light modulation layer.

### BRIEF DESCRIPTION OF THE DRAWINGS

FIG. 1 is a plan view showing a configuration of a reflection type liquid crystal device as an embodiment of a reflection type light modulation device of the present invention.

FIG. 2 is a side sectional view along the II-II line of the reflection type liquid crystal device shown in FIG. 1.

FIG. 3 is a side sectional view showing a configuration of a dielectric multilayer film in an enlarged manner.

FIG. 4 is a side sectional view showing a configuration of a modification example of the dielectric multilayer film.

FIG. 5 includes views showing (a) a configuration in which a first layer in contact with an aluminum substrate is a low refractive index film (SiO₂), and (b) a configuration in which the first layer in contact with the aluminum substrate is a high refractive index film (TiO₂).

FIG. 6 is a graph showing a spectral reflectance in the case where the dielectric multilayer film is not provided on the surface of the aluminum substrate.

FIG. 7 is a graph showing spectral reflectances when the number of lamination layers of the dielectric multilayer film is respectively 2, 4, 6, and 10 in the configuration shown in (a) in FIG. 5.

FIG. 8 is a graph showing spectral reflectances when the number of lamination layers is respectively 4, 6, 10, and 14 in the configuration shown in (a) in FIG. 5.

FIG. 9 is a graph showing spectral reflectances when the number of lamination layers of the dielectric multilayer film is respectively 3, 5, 7, and 9 in the configuration shown in (b) in FIG. 5.

FIG. 10 is a graph showing spectral reflectances when the number of lamination layers is respectively 5, 9, 15, and 21 in the configuration shown in (b) in FIG. 5.

FIG. 11 is a graph showing spectral reflectance characteristics when an SiO₂ film is provided with various optical film thicknesses nd (50 [nm], 150 [nm], and 250 [nm]) on the surface of the aluminum substrate.

FIG. 12 includes views showing (a) a configuration in which a layer in contact with a protective film is a low refractive index film (SiO₂), and (b) a configuration in which the layer in contact with the protective film is a high refractive index film (TiO₂).

FIG. 13 is a graph showing a spectral reflectance when the optical film thickness of the protective film is set to 150 [nm] and a dielectric multilayer film of 6 layers is provided in the configuration shown in (a) in FIG. 12.

FIG. 14 is a graph showing a spectral reflectance when the optical film thickness of the protective film is set to 150 [nm] and a dielectric multilayer film of 5 layers is provided in the configuration shown in (b) in FIG. 12.

FIG. 15 is a graph showing a spectral reflectance when the optical film thickness of the protective film is set to 50 [nm] and an optical film thickness of an upper layer thereof is set to 150 [nm] (that is, the optical film thickness of the low refractive index layer as the first layer is 200 [nm]) in the configuration shown in (a) in FIG. 12.

FIG. 16 is a graph showing a spectral reflectance when the optical film thickness of the protective film is set to 50 [nm] (that is, the optical film thickness of the low refractive index layer as the first layer is 50 [nm]) in the configuration shown in (b) in FIG. 12.

FIG. 17 is a graph showing a spectral reflectance when the optical film thickness of the protective film is set to 250 [nm] and an optical film thickness of an upper layer thereof is set to 150 [nm] (that is, the optical film thickness of the low refractive index layer as the first layer is 400 [nm]) in the configuration shown in (a) in FIG. 12.

FIG. 18 is a graph showing a spectral reflectance when the optical film thickness of the protective film is set to 250 [nm] (that is, the optical film thickness of the low refractive index layer as the first layer is 250 [nm]) in the configuration shown in (b) in FIG. 12.

FIG. 19 includes views showing (a) a configuration in which a layer in contact with a protective film (MgF₂) is a low refractive index film (SiO₂), and (b) a configuration in which the layer in contact with the protective film is a high refractive index film (TiO₂).

FIG. 20 is a view showing incidence of light L from an oblique direction with respect to a dielectric multilayer film.

FIG. 21 is a graph showing examples of the reflectance of the dielectric multilayer film with respect to a P-polarization component and an S-polarization component in the case where a low refractive index layer (SiO₂) as a first layer is disposed on an aluminum substrate.

FIG. 22 is a graph showing examples of the reflectance of the dielectric multilayer film with respect to a P-polarization component and an S-polarization component in the case where a high refractive index layer (TiO₂) as a first layer is disposed on an aluminum substrate.

FIG. 23 is a graph showing spectral reflection characteristics of an Nb₂O₅/SiO₂ dielectric multilayer film in the case where a low refractive index layer (SiO₂, optical film thickness: 150 [nm]) as a first layer is disposed on an aluminum substrate.

FIG. 24 is a graph showing spectral reflection characteristics of an Nb₂O₅/SiO₂ dielectric multilayer film in the case where a high refractive index layer (Nb₂O₅, optical film thickness: 150 [nm]) as a first layer is disposed on an aluminum substrate.

FIG. 25 is a graph showing measurement results of a spectral reflectance of an aluminum mirror.

FIG. 26 is a graph showing measurement results (solid line) of the reflectance of the dielectric multilayer film formed on an aluminum mirror and calculation results (dashed line) of the reflectance of this dielectric multilayer film when a low refractive index layer (SiO₂) is disposed as a first layer in contact with the aluminum mirror.

FIG. 27 is a graph showing measurement results (solid line) of the reflectance of the dielectric multilayer film formed on an aluminum mirror and calculation results (dashed line) of the reflectance of this dielectric multilayer film when a high refractive index layer (TiO₂) is disposed as a first layer in contact with the aluminum mirror.

### DESCRIPTION OF THE SYMBOLS

1—reflection type liquid crystal device, 4—pixel, 12—silicon substrate, 14—drive circuit layer, 16—pixel electrode, 18, 28, 52—dielectric multilayer film, 18a to 18d, 28a to 28d—low refractive index layer, 18e to 18h, 28e to 28h—high refractive index layer, 20—liquid crystal layer, 22—transparent conductive film, 24—transparent substrate, 30—aluminum substrate, 36, 46—protective film, 281—lower layer, 282—upper layer.

### BEST MODES FOR CARRYING OUT THE INVENTION

Hereinafter, embodiments of a reflection type light modulation device according to the present invention will be described in detail with reference to the accompanying drawings. In the description of the drawings, elements identical to each other are designated by the same reference signs to omit overlapping description.

### Embodiment

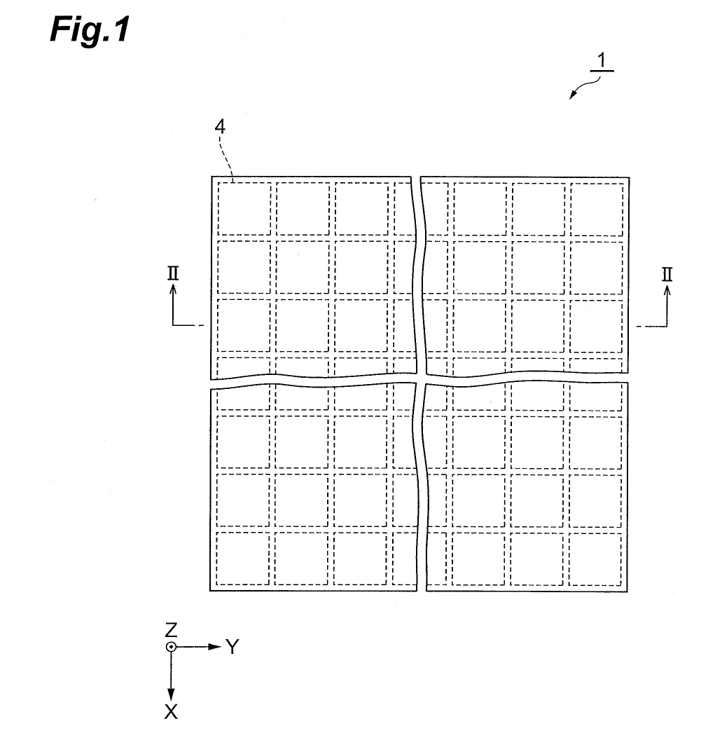

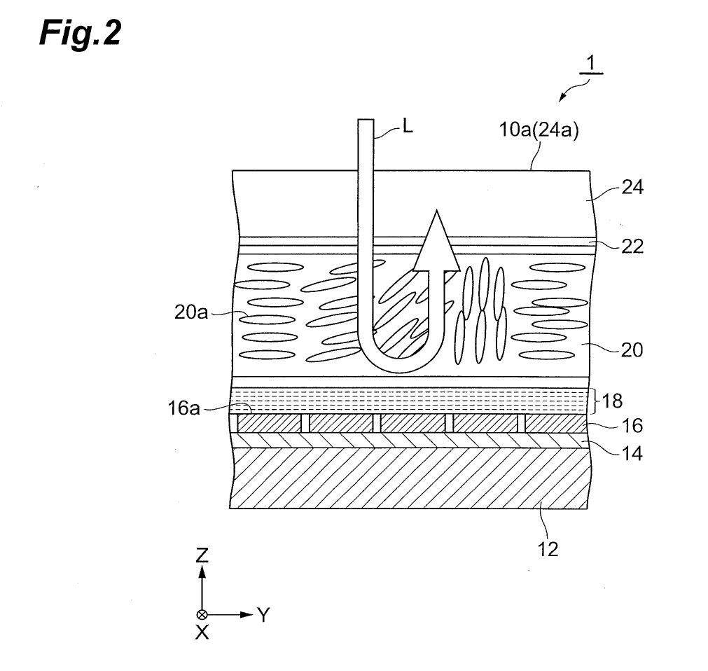

FIG. 1 is a plan view showing a configuration of a reflection type liquid crystal device as an embodiment of a reflection type light modulation device according to the present invention. FIG. 2 is a side sectional view along the II-II line of the reflection type liquid crystal device shown in FIG. 1. Further, in FIG. 1 and FIG. 2, for easy explanation, an XYZ orthogonal coordinate system is shown. The reflection type liquid crystal device 1 of the present embodiment includes, as shown in FIG. 1, a plurality of pixels 4 two-dimensionally arrayed along two axes (X axis and Y axis) orthogonal to each other. The reflection type liquid crystal device 1 modulates light made incident from the front side (Z axis positive side) in each of the pixels 4 and outputs an arbitrary optical image forward while reflecting the light.

Referring to FIG. 2, the reflection type liquid crystal device 1 includes a silicon substrate 12, a drive circuit layer 14, a plurality of pixel electrodes 16, a dielectric multilayer film 18, a liquid crystal layer 20, a transparent conductive film 22, and a transparent substrate 24.

The transparent substrate 24 has a front surface 24a along the XY plane, and the surface 24a constitutes the front surface 10a of the reflection type liquid crystal device 1. The transparent substrate 24 mainly contains a light transmissive material, such as glass, and transmits light L of a predetermined wavelength made incident from the surface 10a of the reflection type liquid crystal device 1 to the inside of the reflection type liquid crystal device 1. Further, the transparent conductive film 22 is a conductive light transmitting layer in the present embodiment. The transparent conductive film 22 is formed on the rear surface 24b of the transparent substrate 24, and mainly contains and is composed of a conductive material (for example, ITO) which transmits the light L.

The plurality of pixel electrodes 16 are two-dimensionally arrayed according to the array of the plurality of pixels 4 shown in FIG. 1, and are arrayed on the silicon substrate 12 along the transparent conductive film 22. The respective pixel electrodes 16 are made of a metal material such as aluminum, and their surfaces 16a are processed to be flat and smooth. The plurality of pixel electrodes 16 are driven by an active matrix circuit provided in the drive circuit layer 14. The active matrix circuit is provided between the plurality of pixel electrodes 16 and the silicon substrate 12, and controls voltages to be applied to the respective pixel electrodes 16 according to an optical image to be output from the reflection type liquid crystal device 1. This active matrix circuit includes, for example, a first driver circuit which controls voltages to be applied to the respective pixel rows arranged in the X-axis direction, and a second driver circuit which controls voltages to be applied to the respective pixel rows arranged in the Y-axis direction, and configured such that the predetermined voltage is applied to the pixel electrode 16 of the designated pixel 4 by both driver circuits.

The liquid crystal layer 20 is a light modulation layer in the present embodiment. The liquid crystal layer 20 is disposed between the plurality of pixel electrodes 16 and the transparent conductive film 22, and modulates the light L according to an electric field formed by each pixel electrode 16 and the transparent conductive film 22. Specifically, when a voltage is applied to a certain pixel electrode 16 by the active matrix circuit, an electric field is formed between the transparent conductive film 22 and this pixel electrode 16. This electric field is applied to each of the dielectric multilayer film 18 and the liquid crystal layer 20 at a ratio corresponding to the respective thicknesses. Then, according to the magnitude of the electric field applied to the liquid crystal layer 20, the alignment direction of the liquid crystal molecules 20a changes. When light L is transmitted through the transparent substrate 24 and the transparent conductive film 22 and made incident on the liquid crystal layer 20, this light L is modulated by the liquid crystal molecules 20a during passage through the liquid crystal layer 20 and reflected by the dielectric multilayer film 18, and then modulated again by the liquid crystal layer 20 and then extracted.

The dielectric multilayer film 18 is disposed between the plurality of pixel electrodes 16 and the liquid crystal layer 20. In particular, the dielectric multilayer film 18 of the present embodiment is formed directly on the surfaces 16a of the plurality of pixel electrodes 16. The dielectric multilayer film 18 reflects the light L at a high reflectance, for example, higher than 99% in cooperation with light reflection action of the surfaces 16a of the pixel electrodes 16.

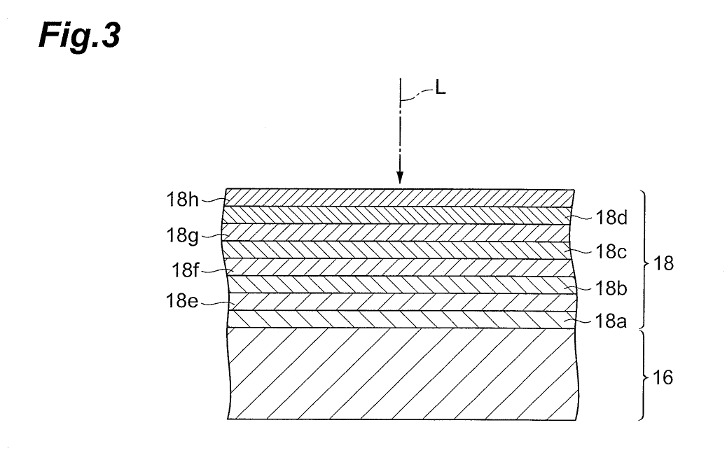

Here, FIG. 3 is a side sectional view showing a configuration of the dielectric multilayer film 18 in an enlarged manner. As shown in FIG. 3, the dielectric multilayer film 18 includes a plurality of low refractive index layers 18a to 18d including a layer 18a (first layer) in contact with the pixel electrodes 16, and a plurality of high refractive index layers 18e to 18h including a layer 18e (second layer) having a refractive index higher than that of the low refractive index layer 18a and being in contact with the low refractive index layer 18a. The low refractive index layers 18a to 18d and the high refractive index layers 18e to 18h are alternately laminated on the pixel electrodes 16. A constituent material of the low refractive index layers 18a to 18d is, for example, SiO₂, MgF₂, and particularly preferably, mainly contains SiO₂. Moreover, a constituent material of the high refractive index layers 18e to 18h is, for example, TiO₂, Nb₂O₅, Ta₂O₅, HfO₂, ZrO₂, or the like, and preferably contains at least one kind among these.

Further, in the present embodiment, a case where the number of lamination layers of the dielectric multilayer film 18 is 8 (four layers each of low refractive index layers 18a to 18d and high refractive index layers 18e to 18h) is shown, however, the number of lamination layers of the dielectric multilayer film 18 is preferably not less than 2 (that is, one or more each of low refractive index layers and high refractive index layers) and not more than 10 (that is, five or less each of low refractive index layers and high refractive index layers). Also, the number of lamination layers of the dielectric multilayer film is not limited to an even number, and may be an odd number. In this case, the dielectric film positioned closest to the liquid crystal layer 20 side in the dielectric multilayer film 18 is a low refractive index layer. In the embodiments shown below, the number of lamination layers of the dielectric multilayer film 18 may be an even number or an odd number, however, the dielectric film positioned closest to the liquid crystal layer 20 side is preferably a high refractive index layer.

Also, the optical film thickness of the low refractive index layer 18a (=n×d, n is a refractive index of the low refractive index layer 18a, and d is a physical film thickness of the low refractive index layer 18a) is preferably set within the range of (λ/4)±30% provided that λ is a wavelength of the light L. Alternatively, the optical film thickness of the low refractive index layer 18a may be set substantially equal to (λ/4)×n (n is an odd number). Further, when the light L is made incident from an oblique direction with respect to the dielectric multilayer film 18, the optical film thickness of the low refractive index layer 18a is preferably set within the range of (λ/4cosθ)±30% provided that θ is an incident angle of the light L inside the low refractive index layer 18a (that is, a relative angle between the direction in which the light L travels in the low refractive index layer 18a and the layer thickness direction). Alternatively, the optical film thickness of the low refractive index layer 18a may be set substantially equal to (λ/4cosθ)×n (n is an odd number). Further, a preferable value of the optical film thickness of the low refractive index layer 18a will be described in detail in examples described later.

The reflection type liquid crystal device 1 of the present embodiment described above has the following effect. In the reflection type liquid crystal device 1, the dielectric multilayer film 18 is formed on the plurality of metallic pixel electrodes 16, so that the reflectance for the light L can be increased by utilizing the high reflectance of the metal surface. Also, as shown in examples described later, when the dielectric multilayer film 18 is formed on a metal surface, the low refractive index layer (first layer) 18a is formed first on the metal surface, and then the high refractive index layer (second layer) 18e is laminated thereon, and accordingly, a sufficient reflectance can be obtained with a number of lamination layers much smaller than in the case where the high refractive index layer is laminated first. Therefore, according to the reflection type liquid crystal device 1 of the embodiment, lowering of efficiency of electric field application to the liquid crystal layer 20 can be suppressed by making the physical film thickness of the dielectric multilayer film 18 thinner than conventionally, and a sufficiently high reflectance is realized and light extraction efficiency can be increased.

### Modification Example

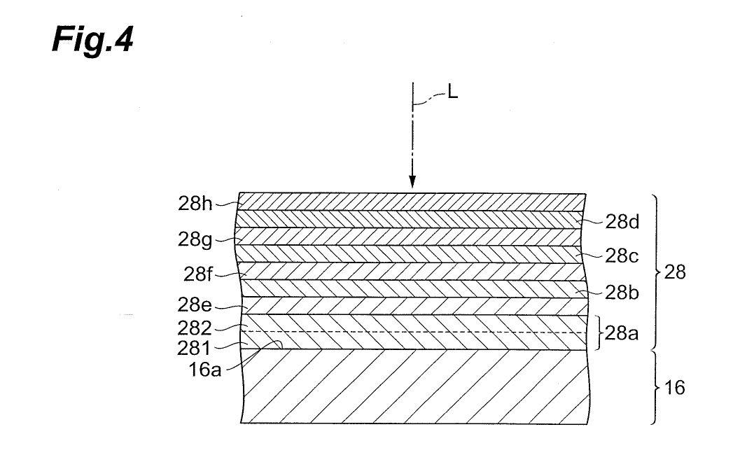

FIG. 4 is a side sectional view showing a configuration of a dielectric multilayer film 28 as a modification example of the above-described embodiment. The reflection type liquid crystal device 1 according to the above-described embodiment may include the dielectric multilayer film 28 shown in FIG. 4 instead of the dielectric multilayer film 18 shown in FIG. 3.

Referring to FIG. 4, the dielectric multilayer film 28 is formed by alternately laminating a plurality of low refractive index layers 28a to 28d including a layer 28a (first layer) in contact with the pixel electrodes 16, and a plurality of high refractive index layers 28e to 28h including a layer 28e (second layer) having a refractive index higher than that of the low refractive index layer 28a and in contact with the low refractive index layer 28a. Further, the respective constituent materials of the low refractive index layers 28b to 28d except for the low refractive index layer 28a, and the high refractive index layers 28e to 28h, are the same as those of the low refractive index layers 18a to 18d and the high refractive index layer 18e to 18h shown in FIG. 3.

The low refractive index layer 28a of the present modification example includes a lower layer 281 in contact with the pixel electrodes 16 and an upper layer 282 sandwiched by the lower layer 281 and the high refractive index layer 28e. The lower layer 281 and the upper layer 282 may be made of the same material, or may be made of different materials. A constituent material of the lower layer 281 is, for example, SiO₂ and MgF₂, and contains at least one kind of these. A constituent material of the upper layer 282 is the same as that of the low refractive index layers 18a to 18d shown in FIG. 3, and particularly preferably, mainly contains SiO₂.

The configuration of the dielectric multilayer film 28 of the present modification example is preferably applied, for example, when an insulating protective film is formed on the surfaces 16a of the pixel electrodes 16. Specifically, the surfaces of components made of a metal such as aluminum (in the present example, pixel electrodes 16) may be coated with a protective film. This protective film is made of, in most cases, SiO₂ or MgF₂, which is a low refractive index substance.

Therefore, when manufacturing the dielectric multilayer film 28, this protective film remains as the lower layer 281 on the surfaces 16a of the pixel electrodes 16, and a low refractive index substance such as SiO₂ is deposited as the upper layer 282 thereon, and accordingly, the low refractive index layer 28a of the modification example can be preferably obtained. Thus, the protective film formed on the surfaces 16a of the pixel electrodes 16 may be utilized as a part (lower layer 281) of the low refractive index layer 28a. Even with this configuration, an effect equivalent to that of the reflection type liquid crystal device 1 of the embodiment described above can be preferably obtained.

In the present modification example, it is also preferable that the number of lamination layers of the dielectric multilayer film 28 is not less than 2 and not more than 10 provided that the low refractive index layer 28a is counted as one layer. Moreover, the optical film thickness of the low refractive index layer 28a (that is, the sum of the optical film thickness of the lower layer 281 and the optical film thickness of the upper layer 282) is preferably set within the range of (λ/4)±30% provided that λ is a wavelength of the light L, and may be set to be substantially equal to (λ/4)×n (n is an odd number). When the light L is made incident from an oblique direction with respect to the dielectric multilayer film 28, the optical film thickness of the low refractive index layer 28a is preferably set within the range of (λ/4cosθ)±30% provided that θ is an incident angle of the light L in the low refractive index layer 28a, and may be set to be substantially equal to (λ/4cosθ)×n (n is an odd number).

### EXAMPLE 1

### Reflectance of Dielectric Multilayer Film On Aluminum

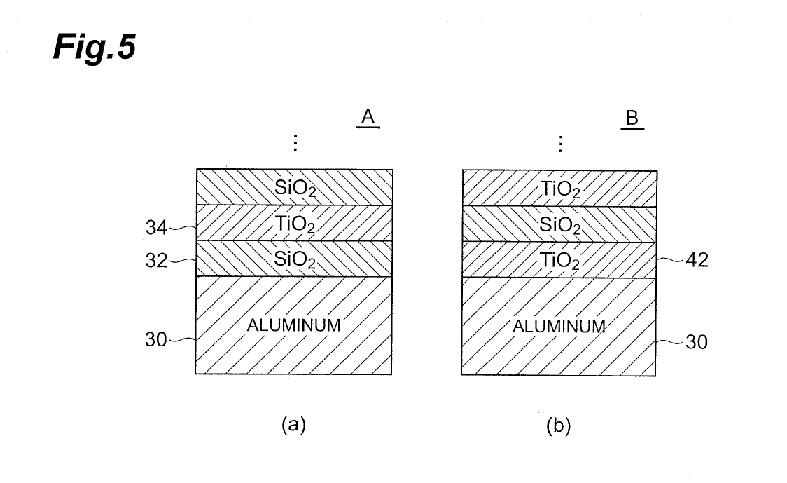

A spectral reflectance when the dielectric multilayer film was formed on an aluminum substrate was investigated. As the constituent materials of the dielectric multilayer film, the low refractive index layers were made of SiO₂, and the high refractive index layers were made of TiO₂. And, the wavelength of incident light was assumed to be λ=600 [nm], and the optical film thickness of each of the layers was set to 150 [nm] (that is, λ/4). As a lamination configuration of the dielectric multilayer film, configuration A in which the first layer 32 in contact with the aluminum substrate 30 is a low refractive index film (SiO₂) as shown in (a) in FIG. 5, and configuration B in which the first layer 42 in contact with the aluminum substrate 30 is a high refractive index film (TiO₂) as shown in (b) in FIG. 5, are possible.

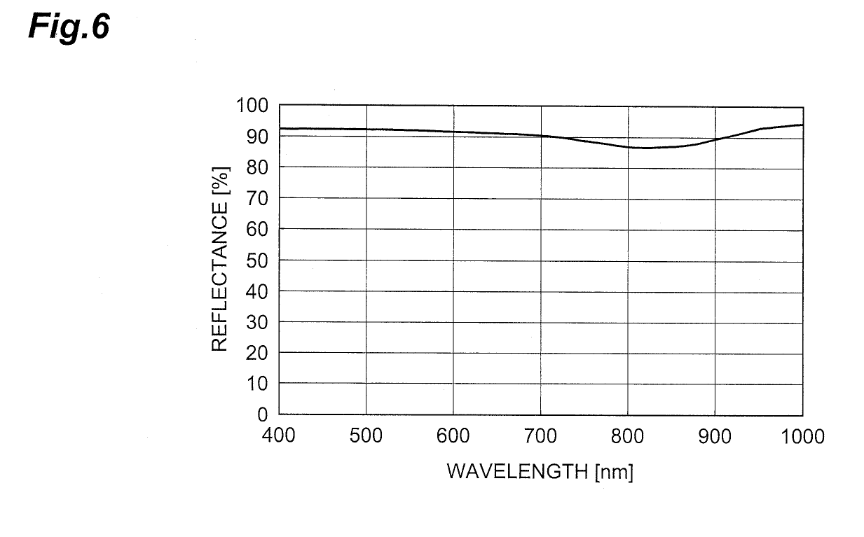

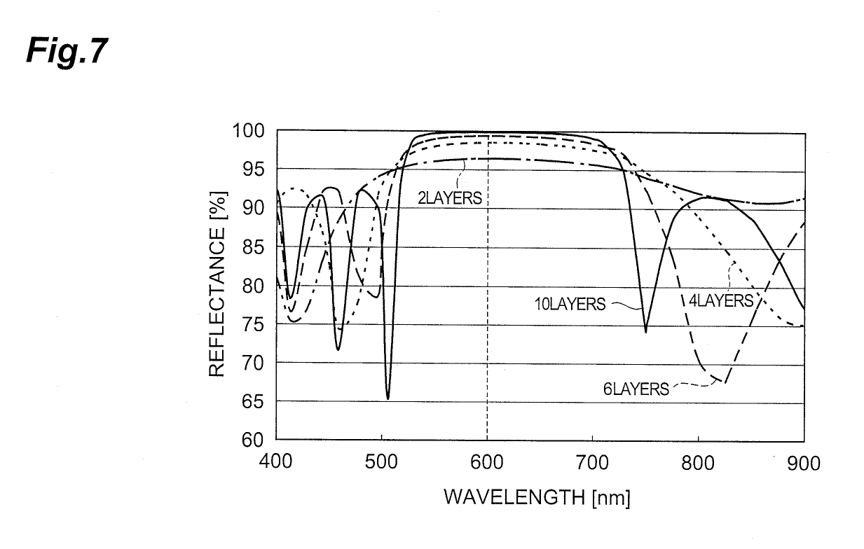

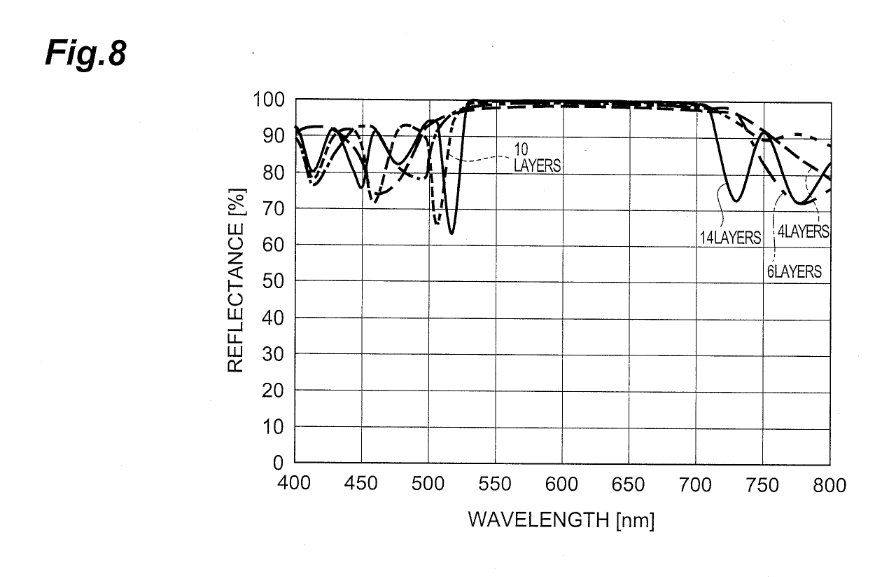

FIG. 6 is a graph showing a spectral reflectance when the dielectric multilayer film is not provided on the surface of the aluminum substrate. FIG. 7 is a graph showing spectral reflectances when the number of lamination layers in the dielectric multilayer film is respectively 2, 4, 6, and 10 in the configuration A shown in FIG. 5(a). FIG. 8 is a graph showing spectral reflectances when the number of lamination layers is respectively 4, 6, 10, and 14 in the configuration A.

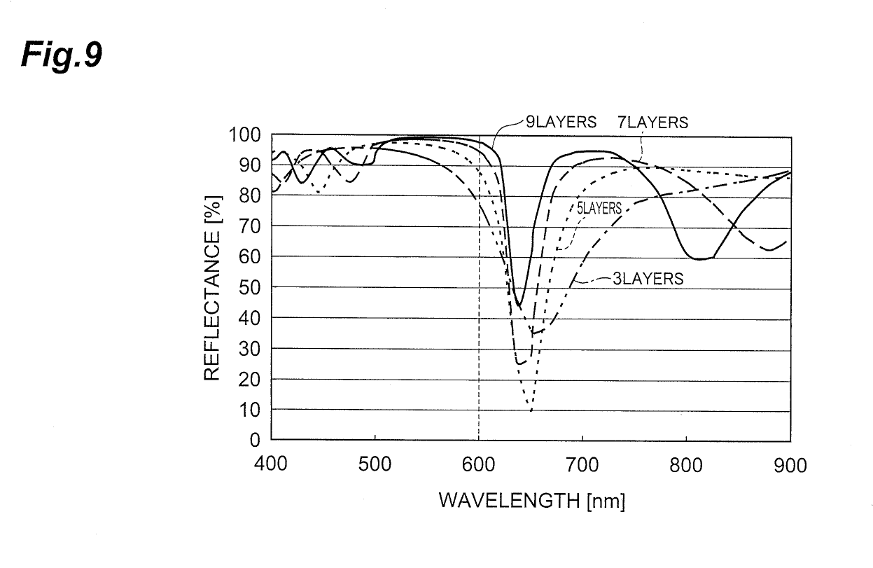

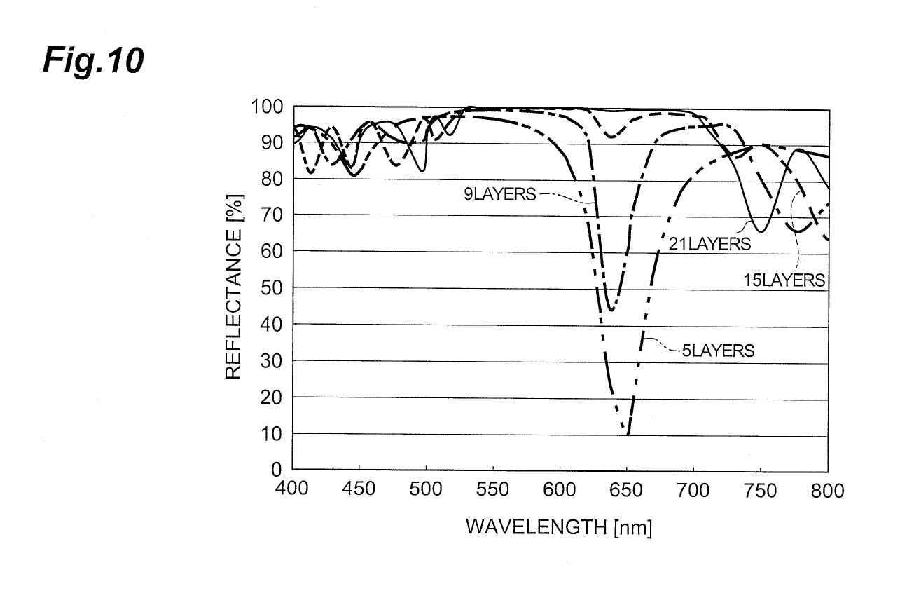

FIG. 9 is a graph showing spectral reflectances when the number of lamination layers in the dielectric multilayer film is respectively 3, 5, 7, and 9 in the configuration B shown in FIG. 5(b). FIG. 10 is a graph showing spectral reflectances when the number of lamination layers is respectively 5, 9, 15, and 21 in the configuration B.

In the configuration A shown in FIG. 5(a), as shown in FIG. 7, the reflectance at a wavelength of 600 [nm] when the number of lamination layers is set to 2 (that is, one each of SiO₂ low refractive index layer and TiO₂ high refractive index layer) is over 95%, and is higher than the reflectance of the aluminum substrate (see FIG. 6). Moreover, as shown in FIG. 7 and FIG. 8, when the number of lamination layers is set to 6 (three each of SiO₂ low refractive index layers and TiO₂ high refractive index layers), the reflectance at a wavelength of 600 [nm] is over 99%, and when the number of lamination layers is set to 10 (five each of SiO₂ low refractive index layers and TiO₂ high refractive index layers), the reflectance is 99.8%.

On the other hand, in the configuration B shown in FIG. 5(b), as shown in FIG. 9 and FIG. 10, a phenomenon in which the reflectance is lowered at a wavelength near 600 [nm] of the incident light is observed. The degree of this lowering of the reflectance is reduced when the number of lamination layers is not less than 21, however, when the number of lamination layers is smaller than 10, a sufficient reflectance at a desired wavelength cannot be obtained.

Further, Table 1 shown below summarizes the numbers of lamination layers, the reflectances, and the thicknesses (physical film thicknesses) of the dielectric multilayer film in the configurations A and B, respectively. Moreover, the bold texts in Table 1 show values preferable in the reflection type liquid crystal device. As shown in Table 1, in the configuration B, when the number of lamination layers is set to 11 or more, the reflectance becomes not less than 99%, and when the number of lamination layers is set to 15 or more, the reflectance becomes not less than 99.8%. Thus, it is understood that, even with the configuration B, a reflectance sufficient in the reflection type liquid crystal device can be obtained by increasing the number of lamination layers. However, if the number of lamination layers is not less than 11, the thickness becomes more than 0.9 [μm], and when the number of lamination layers is not less than 15, the thickness becomes more than 1.2 [μm]. If the dielectric multilayer film thus becomes thicker, as described above, the efficiency of electric field application to the liquid crystal layer (light modulation layer) is lowered, and this is not preferable. On the other hand, in the configuration A, even when the number of lamination layers is only 6, the reflectance becomes not less than 99%, and at the point where the number of lamination layers is set to 10, the reflectance becomes not less than 99.8%. In these cases, when the number of lamination layers is 6, the thickness is approximately 0.5 [μm], and when the number of lamination layers is 10, the thickness is approximately 0.8 [μm], so that the dielectric multilayer film can be formed to be extremely thinner than in the case of the configuration B.

TABLE 1

| Configuration A | | | Configuration B | | |
|---|---|---|---|---|---|
| | | Thickness of | | | Thickness of |
| Number | Reflectance | dielectric multilayer | Number | Reflectance | dielectric multilayer |
| of | (wavelength | film (physical | of | (wavelength | film (physical |
| layers | 600 nm) | film thickness) [nm] | layers | 600 nm) | film thickness) [nm] |
| 4 | 98.515 | 337.64 | 5 | 87.798 | 403.72 |
| 6 | 99.388 | 506.46 | 7 | 94.634 | 572.54 |
| 8 | 99.748 | 675.28 | 9 | 97.754 | 741.36 |
| 10 | 99.897 | 844.10 | 11 | 99.072 | 910.17 |
| 12 | 99.958 | 1012.91 | 13 | 99.618 | 1078.99 |
| 14 | 99.983 | 1181.73 | 15 | 99.843 | 1247.81 |
| 16 | 99.993 | 1350.55 | 17 | 99.936 | 1416.63 |
| 18 | 99.997 | 1519.37 | 19 | 99.974 | 1585.45 |
| 20 | 99.999 | 1688.19 | 21 | 99.989 | 1754.27 |

From these results, it is shown that, by forming the dielectric multilayer film on the aluminum substrate, a high reflectance can be realized with a small number of lamination layers of not more than 10. However, in order to increase the reflectance with respect to light of a predetermined wavelength by preferable reflection characteristics, as in the case of the configuration A, a low refractive index layer is formed first as a first layer 32 on the surface of the aluminum substrate 30, and then a high refractive index layer is laminated thereon as a second layer 34. Accordingly, a sufficient reflectance can be obtained with the number of lamination layers much smaller than in the case where the high refractive index layer is laminated first as in the configuration B, and therefore, lowering of efficiency of electric field application to the light modulation layer can be effectively suppressed.

### EXAMPLE 2

### When the Surface of Aluminum Is Coated With Protective Film

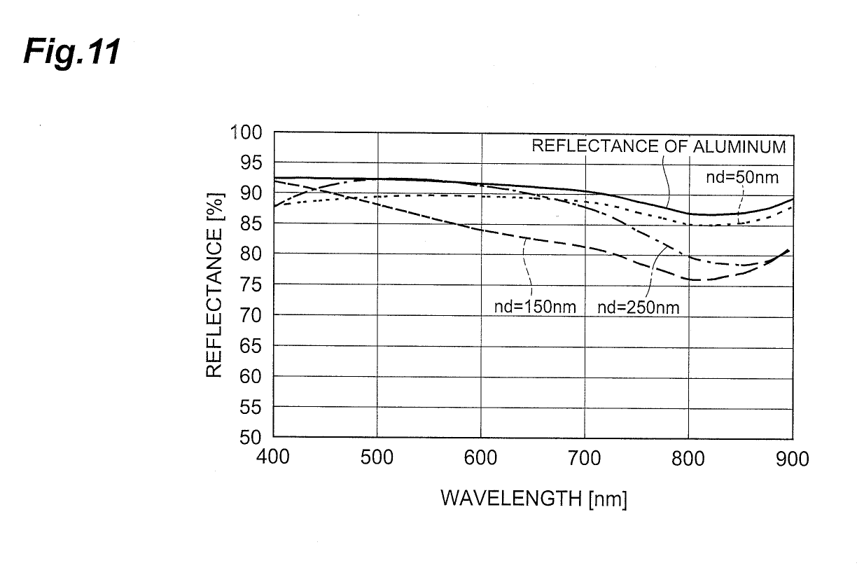

A case where the surface of aluminum is coated with a protective film is described. Most of the constituent materials of the protective film are low refractive index substances of SiO₂ and MgF₂. FIG. 11 is a graph showing spectral reflectance characteristics when an SiO₂ film is provided with various optical film thicknesses nd (50 [nm], 150 [nm], and 250 [nm]) on the surface of the aluminum substrate. Referring to FIG. 11, at a wavelength four times as long as the optical film thickness nd, the reflectance when the SiO₂ film is provided on the aluminum substrate is reduced by the reflection reducing effect of the SiO₂ film, compared to the reflectance of the aluminum surface. On the other hand, at a wavelength twice as long as the optical film thickness nd, the SiO₂ film hardly influences the reflectance, and the reflectance when the SiO₂ film is provided on the aluminum substrate becomes equal to the reflectance of the aluminum surface. For example, in FIG. 11, the reflectance at a wavelength of 500 [nm] when the optical film thickness nd is 250 [nm] becomes equal to the reflectance of the aluminum surface. Therefore, the optical film thickness of the protective film is generally set to ½ of the wavelength in use to prevent lowering of the reflectance.

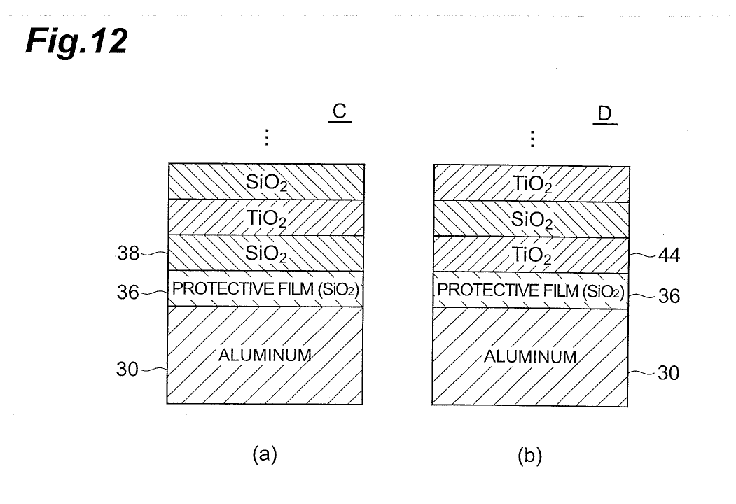

Here, a case where the dielectric multilayer film is formed on the protective film of the aluminum substrate is considered. In this case, the protective film may be regarded as a part of the configuration of the dielectric multilayer film. As a lamination configuration of the dielectric multilayer film in this case, a configuration C in which the layer 38 in contact with the protective film 36 is a low refractive index film (SiO₂) as shown in (a) in FIG. 12, and a configuration D in which the layer 44 in contact with the protective film 36 is a high refractive index film (TiO₂) as shown in (b) in FIG. 12, are possible. In the configuration C, the low refractive index layer (first layer) in contact with the aluminum substrate consists of the protective film 36 and the layer 38, and in the configuration D, the low refractive index layer (first layer) in contact with the aluminum substrate consists of only the protective film 36.

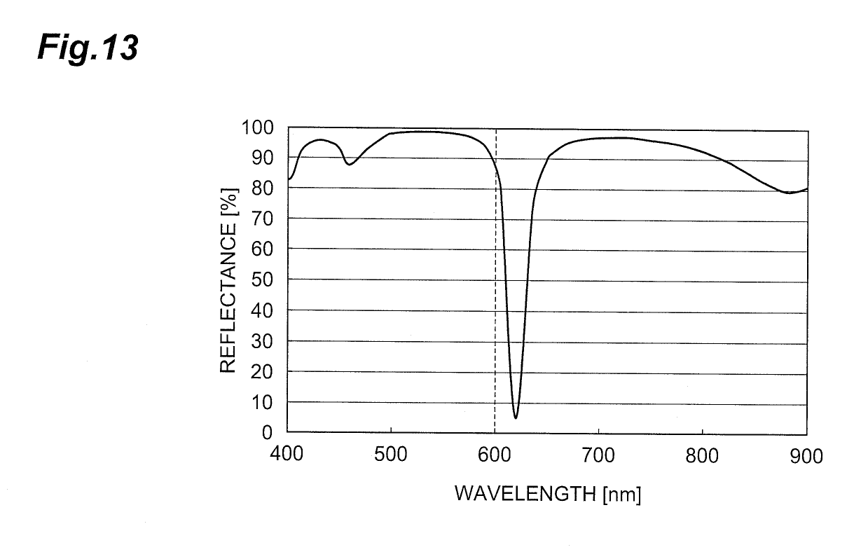

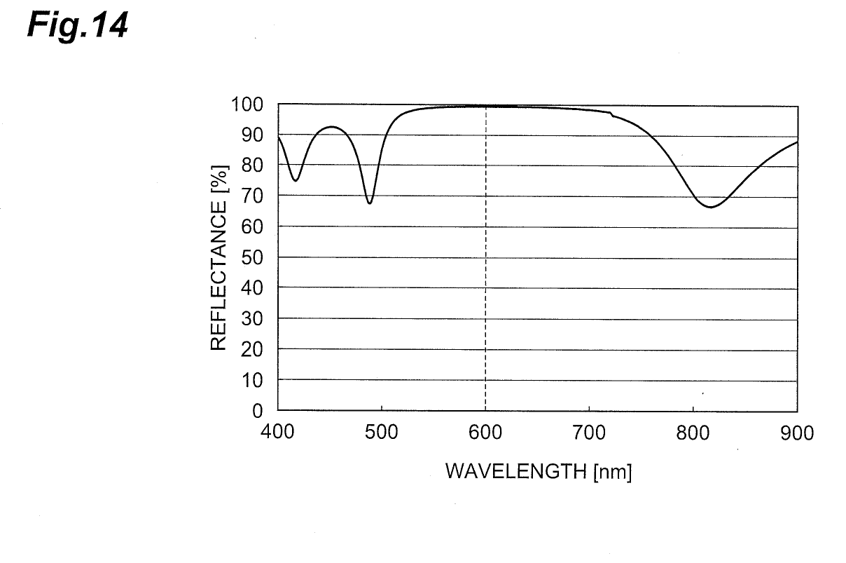

FIG. 13 is a graph showing a spectral reflectance when the optical film thickness of the protective film 36 is set to 150 [nm] and a dielectric multilayer film including 6 layers is provided in the configuration C. Moreover, FIG. 14 is a graph showing a spectral reflectance when the optical film thickness of the protective film 36 is set to 150 [nm] and a dielectric multilayer film including 5 layers is provided in the configuration D. In FIG. 13 and FIG. 14, the wavelength of incident light is assumed to be 600 [nm], and the optical film thickness of each layer constituting the dielectric multilayer film is set to 150 [nm].

When the protective film 36 with the optical film thickness of λ/4 is provided on the aluminum substrate 30 as in the present example, as shown in FIG. 13 and FIG. 14, the spectral reflection characteristics become more excellent and the reflectance at a wavelength of incident light of λ=600 [nm] becomes higher in the configuration D in which the high refractive index film (TiO₂) is laminated first (see FIG. 12(b)) than in the configuration C in which the low refractive index film (SiO₂) is laminated first (see FIG. 12(a)).

In the configuration C, the low refractive index layer (first layer) consists of the protective film 36 and the layer 38, however, the optical film thicknesses of the protective film 36 and the layer 38 are respectively λ/4, so that the optical film thickness of the first layer becomes λ/2 (300 [nm]), and the protective film 36 and the layer 38 hardly influence the reflectance. Therefore, it is presumed that the spectral reflection characteristics of the configuration C are substantially the same as in the configuration B (see FIG. 5(b)) in which the first layer in contact with the aluminum substrate is a high refractive index film, and becomes the characteristics as shown in FIG. 13.

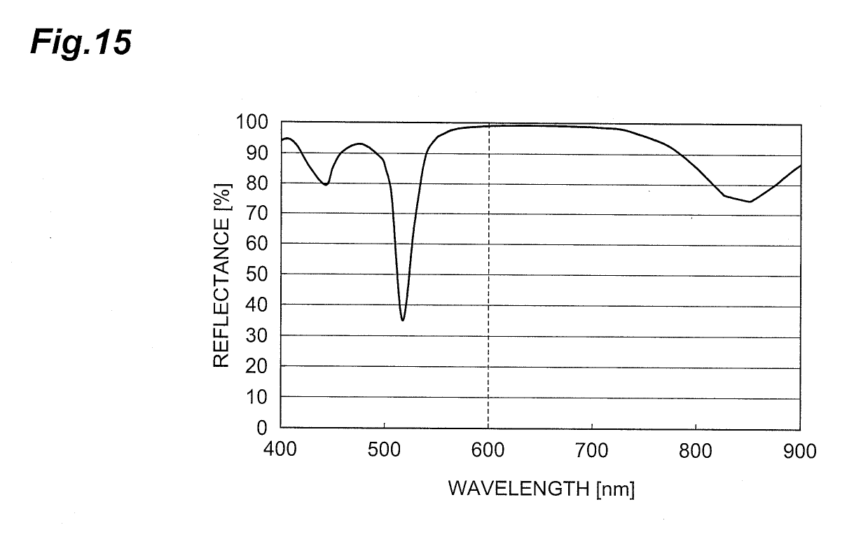

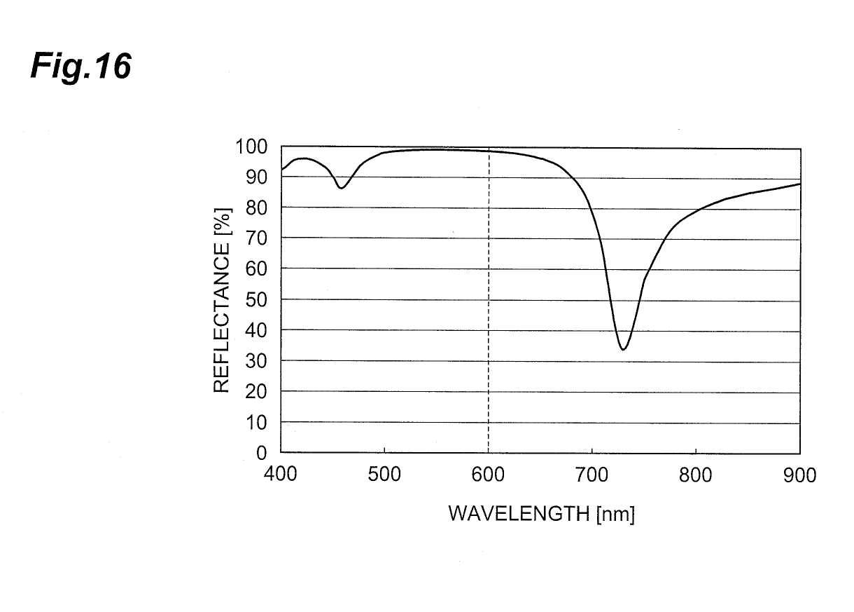

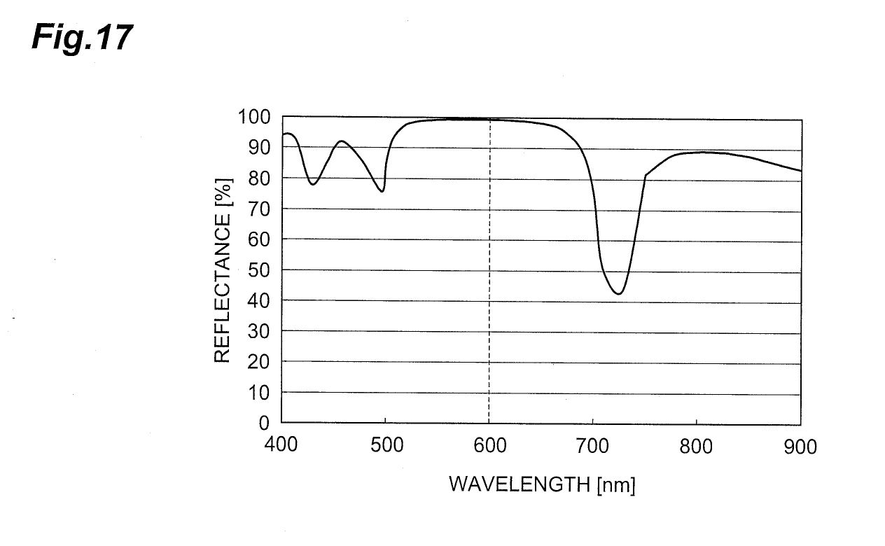

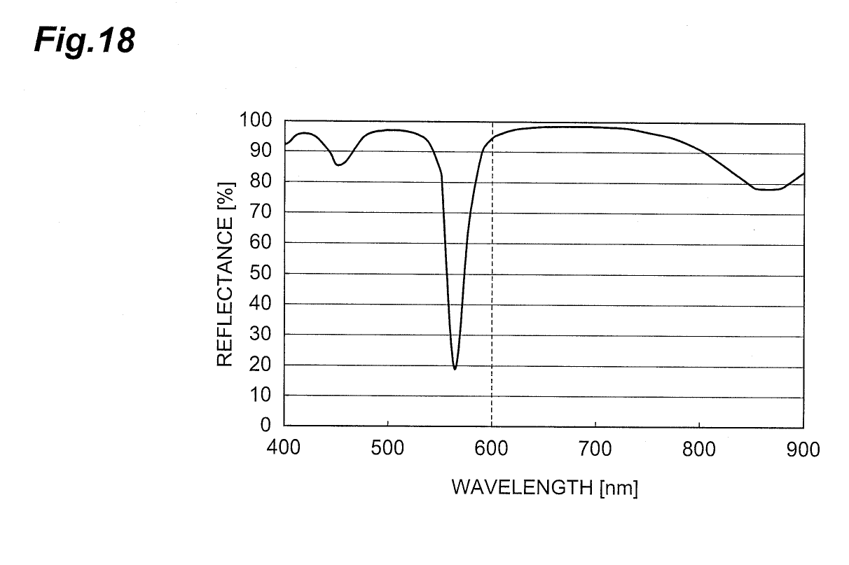

FIG. 15 is a graph showing a spectral reflectance when the optical film thickness of the protective film 36 is set to 50 [nm] and the optical film thickness of the layer 38 is set to 150 [nm] (that is, the optical film thickness of the low refractive index layer as the first layer is 200 [nm]) in the configuration C of the present example. Moreover, FIG. 16 is a graph showing a spectral reflectance when the optical film thickness of the protective film 36 is set to 50 [nm] (that is, the optical film thickness of the low refractive index layer as the first layer is 50 [nm]) in the configuration D of the present example. Further, FIG. 17 is a graph showing a spectral reflectance when the optical film thickness of the protective film 36 is set to 250 [nm] and the optical film thickness of the layer 38 is set to 150 [nm] (that is, the optical film thickness of the low refractive index layer as the first layer is 400 [nm]) in the configuration C. Further, FIG. 18 is a graph showing a spectral reflectance when the optical film thickness of the protective film 36 is set to 250 [nm] (that is, the optical film thickness of the low refractive index layer as the first layer is 250 [nm]) in the configuration D.

The following Table 2 shows optical film thicknesses of the low refractive index layer as the first layer, optical film thickness deviations from λ/4 or 3λ/4 (λ=600 [nm]), reflectances at the wavelength λ, and whether the reflectances are suitable or not when they are adopted in the reflection type light modulation device. Moreover, in Table 2, the reflectances not less than 99% are judged as suitable (shown by circles).

TABLE 2

| Optical film | | | | Suitable/ |
|---|---|---|---|---|
| thickness of low | Spectral | | Reflectance at | unsuitable |
| refractive index | reflection | Deviation from | wavelength λ | for |
| layer [nm] | characteristics | λ/4 or 3λ/4 | [%] | reflectance |
| 150 + 150 = 300 | FIG. 13 | λ/4 × 2 (= λ/2) | 86.9 | |
| 150 + 0 = 150 | FIG. 14 | λ/4 × 1 | 99.4 | ◯ |
| 50 + 150 = 200 | FIG. 15 | λ/4 × 1.33 | 99.0 | ◯ |
| 50 + 0 = 50 | FIG. 16 | λ/4 × 0.33 | 98.7 | |
| 250 + 150 = 400 | FIG. 17 | 3λ/4 × 0.88 | 99.3 | ◯ |
| 250 + 0 = 250 | FIG. 18 | λ/4 × 1.66 | 94.5 | |

As shown in FIG. 13 to FIG. 18 and Table 2, when the optical film thickness of the low refractive index layer as the first layer is λ/4 (in the present example, 150 [nm]) or 3λ/4 (in the present example, 450 [nm]), the highest reflectance can be obtained. It is also shown that a sufficient reflectance can be obtained in the reflection type light modulation device even when the optical film thickness of the low refractive index layer slightly deviates from λ/4.

Here, Tables 3 to 5 show the optical film thicknesses of the low refractive index layer as the first layer, optical film thickness deviations from λ/4, and reflectances at the wavelength λ, when the wavelength λ of the incident light is respectively 1550 [nm], 1200 [nm], 1000 [nm], 800 [nm], 600 [nm], and 400 [nm]. Moreover, the bold texts in Tables 3 to 5 show values preferable in the reflection type liquid crystal device.

TABLE 3

| λ = 1550 [nm] | | | λ = 1200 [nm] | | |
|---|---|---|---|---|---|
| Optical film | Deviation | Reflec- | Optical film | Deviation | Reflec- |
| thickness | from λ/4 | tance | thickness | from λ/4 | tance |
| [nm] | [%] | [%] | [nm] | [%] | [%] |
| 193.8 | −50 | 98.0 | 150.0 | −50 | 97.4 |
| 232.5 | −40 | 98.7 | 180.0 | −40 | 98.3 |
| 271.3 | −30 | 99.0 | 210.0 | −30 | 98.7 |
| 387.5(λ/4) | 0 | 99.4 | 300(λ/4) | 0 | 99.2 |
| 503.8 | 30 | 99.5 | 390.0 | 30 | 99.2 |
| 542.5 | 40 | 99.4 | 420.0 | 40 | 99.1 |
| 581.3 | 50 | 99.3 | 450.0 | 50 | 99.0 |

TABLE 4

| λ = 1000 [nm] | | | λ = 800 [nm] | | |
|---|---|---|---|---|---|
| Optical film | Deviation | Reflec- | Optical film | Deviation | Reflec- |
| thickness | from λ/4 | tance | thickness | from λ/4 | tance |
| [nm] | [%] | [%] | [nm] | [%] | [%] |
| 125.0 | −50 | 97.9 | 100.0 | −50 | 95.2 |
| 150.0 | −40 | 98.4 | 120.0 | −40 | 96.4 |
| 175.0 | −30 | 98.8 | 140.0 | −30 | 97.1 |
| 250(λ/4) | 0 | 99.1 | 200(λ/4) | 0 | 97.8 |
| 325.0 | 30 | 99.0 | 260.0 | 30 | 97.5 |
| 350.0 | 40 | 98.8 | 280.0 | 40 | 97.1 |
| 375.0 | 50 | 98.5 | 300.0 | 50 | 96.4 |

TABLE 5

| λ = 600 [nm] | | | λ = 400 [nm] | | |
|---|---|---|---|---|---|
| Optical film | Deviation | Reflec- | Optical film | Deviation | Reflec- |
| thickness | from λ/4 | tance | thickness | from λ/4 | tance |
| [nm] | [%] | [%] | [nm] | [%] | [%] |
| 75 | −50 | 99.2 | 50 | −50 | 99.6 |
| 90 | −40 | 99.3 | 60 | −40 | 99.6 |
| 105 | −30 | 99.4 | 70 | −30 | 99.7 |
| 150(λ/4) | 0 | 99.4 | 100(λ/4) | 0 | 99.6 |
| 195 | 30 | 99.1 | 130 | 30 | 99 |
| 210 | 40 | 98.7 | 140 | 40 | 98.3 |
| 225 | 50 | 98.1 | 150 | 50 | 96.3 |

The refractive indexes of the low refractive index layer and the aluminum substrate surface include wavelength dispersion, so that as shown in Tables 3 to 5, the reflectance value differs according to each wavelength. However, it is shown that a sufficient reflectance can be obtained in the reflection type liquid crystal device at any wavelength as long as the optical film thickness of the low refractive index layer (first layer) is within the range of ±30% of λ/4.

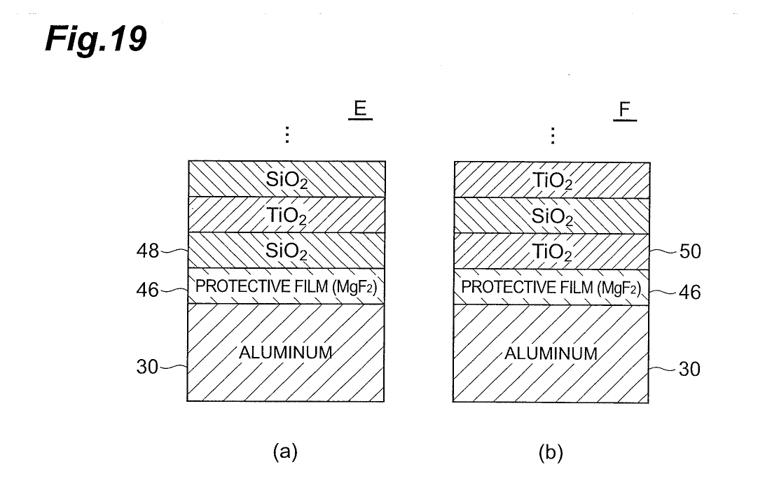

Next, results of the investigation when the protective film is made of MgF₂ are shown. In this case, a configuration E in which the layer 48 in contact with the protective film 46 (MgF₂) is a low refractive index film (SiO₂) as shown in (a) in FIG. 19, and a configuration F in which the layer 50 in contact with the protective film 46 is a high refractive index film (TiO₂) as shown in (b) in FIG. 19, are possible. In the configuration E, the low refractive index layer (first layer) in contact with the aluminum substrate consists of the protective film 46 and the layer 48, and in the configuration F, the low refractive index layer (first layer) in contact with the aluminum substrate consists of only the protective film 46. Table 6 shows the optical film thicknesses of the low refractive index layer as the first layer, optical film thickness deviations from λ/4 or 3λ/4 (λ=600 [nm]), reflectances at the wavelength λ, and whether the reflectances are suitable or not when they are adopted in the reflection type light modulation device in the case where the optical film thicknesses of the protective film 46 and the layer 48 are set variously. Moreover, also in Table 6, the reflectances not less than 99% are judged as suitable (shown by circles).

TABLE 6

| | | Reflectance | Suitable/ |
|---|---|---|---|
| Optical film thickness of | Deviation | at | unsuitable |
| low refractive index layer | from | wavelength | for |
| [nm] | λ/4 or 3λ/4 | λ [%] | reflectance |
| 150(MgF₂) + 150(SiO₂) = 300 | λ/4 × 2 | 85.8 | |
| | (=λ/2) | | |
| 150(MgF₂) + 0(SiO₂) = 150 | λ/4 × 1 | 99.5 | ◯ |
| 50(MgF₂) + 150(SiO₂) = 200 | λ/4 × 1.33 | 99.0 | ◯ |
| 50(MgF₂) + 0(SiO₂) = 50 | λ/4 × 0.33 | 87.8 | |
| 250(MgF₂) + 150(SiO₂) = 400 | 3λ/4 × 0.88 | 99.3 | ◯ |
| 250(MgF₂) + 0(SiO₂) = 250 | λ/4 × 1.66 | 95.3 | |

As shown in Table 6, evaluating the protective film 46 (MgF₂) and the layer 48 (SiO₂) as one low refractive index layer (first layer), results substantially the same as in Table 2 described above are obtained. Also, even when the design was made by setting a wavelength other than 600 [nm] as λ, a reflectance sufficient for the reflection type liquid crystal device is obtained as long as the sum of the optical film thicknesses of the protective film 46 (MgF₂) and the layer 48 (SiO₂) is within the range of ±30% of λ/4.

Specifically, according to the results of the present example, it is shown that a reflectance sufficient for the reflection type light modulation device is obtained as long as the optical film thickness of the first layer, as the low refractive index layer (first layer) including the protective film and in contact with the aluminum substrate, is substantially equal to λ/4×n (n is an odd number). It is also shown that a reflectance sufficient for the reflection type light modulation device is obtained even if the optical film thickness of the first layer is within the range of ±30% of λ/4.

Si₃N₄ is also usable as a constituent material of the protective film. Si₃N₄ has a refractive index of 2.0 to 2.1, and is sorted as a high refractive index substance in the dielectric multilayer film. As described above, a low refractive index layer is preferably directly disposed on the aluminum substrate, however, if a protective film with a high refractive index such as Si₃N₄ has already been provided, a high refractive index layer is formed first on the protective film, and the optical film thickness of the layer (third layer) consisting of this high refractive index layer and the protective film is set to be substantially equal to λ/2×n (n is an odd number), and accordingly, the influence on the reflectance can be made very small. Therefore, by forming a dielectric multilayer film in which a low refractive index layer (first layer) is formed first on the third layer with a high refractive index, substantially the same reflection characteristics as those of the configuration A (see FIG. 5(a)) can be realized.

### EXAMPLE 3

### When Light Is Made Incident From An Oblique Direction With Respect To Dielectric Multilayer Film

Next, influence of the incident angle of light on the dielectric multilayer film on the reflectance will be described. The optical distance of traveling in a certain layer of light made incident on the layer at an incident angle θ is obtained by multiplying the optical film thickness of this layer in the thickness direction by cosθ. Moreover, the following equation (1) (Snell's law) is established among the refractive indexes n₁ and n₂ of each medium at the interface between the media with different refractive indexes and the incident angle θ₁ and the refraction angle θ₂ of light.

[Equation 1]

n₁ sin θ₁=n₂ sin θ₂ (1)

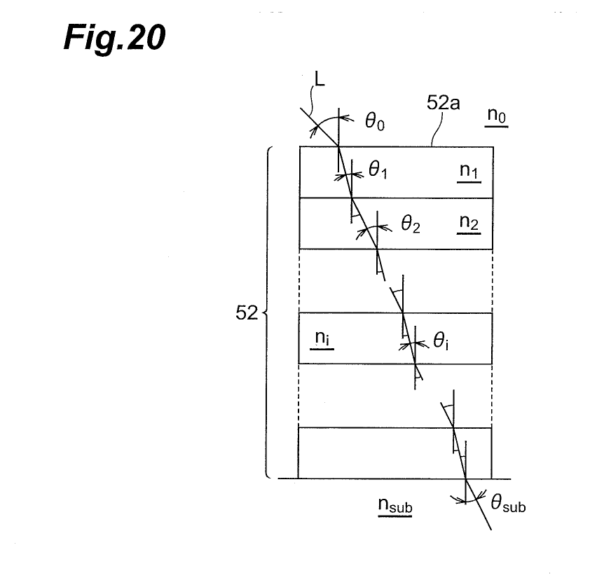

As shown in FIG. 20, when n₀ is the refractive index of the medium in contact with the surface of the dielectric multilayer film 52, θ₀ is an incident angle of the light L on the surface 52a of the dielectric multilayer film 52, n_{sub} is the refractive index of the substrate, and θ_{sub} is an incident angle of the light L on the substrate, the relationship between the refractive index nᵢ of the i-th layer from the surface in the dielectric multilayer film 52 and its incident angle (refraction angle) θᵢ can be expressed by the following equation (2):

[Equation 2]

n₀ sin θ₀=nᵢ sin θᵢ=n_{sub} sin θ_{sub} (2)

by applying the above-described Snell's law. Therefore, according to the equation (2), the inclination of the light traveling direction in each layer within the dielectric multilayer film 52 can be obtained.

From the description given above, when the dielectric multilayer film for oblique incidence is designed, a value obtained by dividing the optical film thickness at an incident angle of zero by cosθᵢ may be newly set as the optical film thickness. Therefore, when this is applied to the results of Example 2 described above, the optical film thickness of the low refractive index layer (first layer) in contact with the aluminum substrate is preferably substantially equal to (λ/4cosθᵢ)×n (n is an odd number), or within the range of ±30% of (λ/4cosθᵢ). This θᵢ is obtained according to the following equation (3).

$$[ Equation 3 ]$$

$${θ}_{i} = {sin}^{- 1} ( \frac{{n}_{0} sin {θ}_{0}}{{n}_{i}} ) \qquad ( 3 )$$

Specific numerical value examples are shown. For example, when light is made incident at an incident angle of 45° on the dielectric multilayer film formed by alternately laminating TiO₂ high refractive index layers and SiO₂ low refractive index layers, the incident angle (refraction angle) θ_{TiO2} inside the TiO₂ high refractive index layer becomes the value shown by the following equation (4). Here, in the equation (4), the refractive index n_{TiO2} of TiO2 is 2.27. The medium in contact with the surface of the dielectric multilayer film is air (n₀=1).

$$[ Equation 4 ]$$

$${θ}_{{TiO}_{2}} = {sin}^{- 1} ( \frac{{n}_{0} sin 45}{{n}_{{TiO}_{2}}} ) = 18.1496 … [ degree ] \qquad ( 4 )$$

Similarly, the incident angle (refraction angle) θ_{SiO2} inside the SiO₂ low refractive index layer becomes the value shown by the following equation (5). In the equation (5), the refractive index n_{SiO2} of SiO₂ is 1.46.

$$[ Equation 5 ]$$

$${θ}_{{SiO}_{2}} = {sin}^{- 1} ( \frac{{n}_{0} sin 45}{{n}_{{SiO}_{2}}} ) = 28.9679 … [ degree ] \qquad ( 5 )$$

Therefore, by arranging the configuration so that the results of respective multiplication of the optical film thicknesses of the TiO₂ high refractive index layer and the SiO₂ low refractive index layer by cos(18.1° and) cos(29.0°), respectively, become 150 [nm], the dielectric multilayer film for 45° incidence at a wavelength λ=600 [nm] can be preferably realized. Specifically, the optical film thickness nd of the TiO₂ high refractive index layers is preferably set to:

[Equation 6]

nd=150/cos 18.1 =157.8 [nm] (6)

and the optical film thickness nd of the SiO₂ low refractive index layers is preferably set to:

[Equation 7]

nd=150/cos 29.0=171.5 [nm] (7)

Thus, even in this case where the dielectric multilayer film is adapted to incidence from an oblique direction, by correcting the optical film thicknesses of the respective layers according to the incident angle taking the optical film thickness nd=λ/4 as a standard, a dielectric multilayer film for oblique incidence can be preferably realized.

Moreover, in the case of oblique incidence, the refractive indexes n_{S} and n_{P} with respect to an S-polarization component and a P-polarization component of the light are:

[Equation 8]

n_{S}=n cos θ

n_{P}=n/cos θ (8)

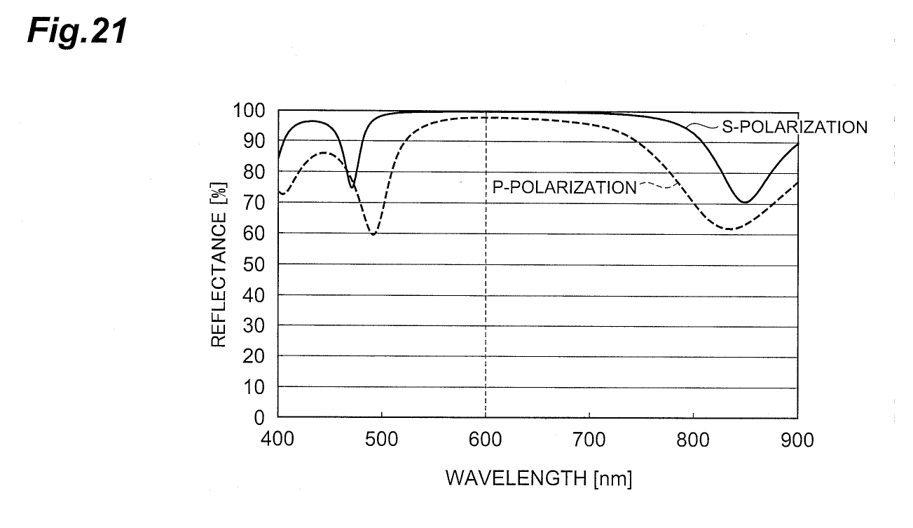

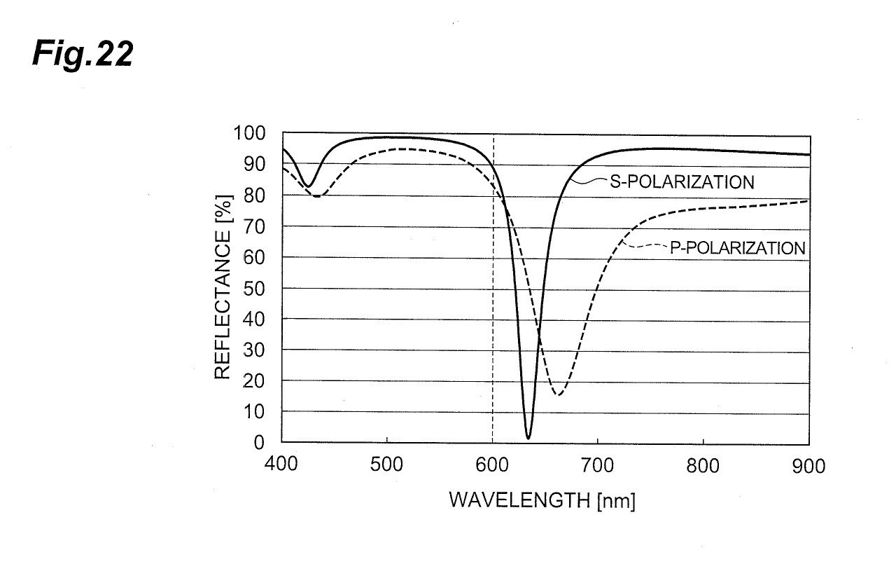

provided that n is a refractive index inside the layer and θ is an incident angle (refraction angle) inside the layer. Thus, the refractive index inside the layer is different between each of the polarization components, so that the reflectance on the dielectric multilayer film is also different. FIG. 21 and FIG. 22 are graphs showing examples of the reflectances of the dielectric multilayer film with respect to the P-polarization component and the S-polarization component. Further, FIG. 21 shows a case where a low refractive index layer (SiO₂) is disposed as a first layer on the aluminum substrate (see FIG. 5(a)), and FIG. 22 shows a case where a high refractive index layer (TiO₂) is disposed as a first layer on the aluminum substrate (see FIG. 5(b)).

### EXAMPLE 4

### When Various Materials Are Used For the High Refractive Index Layer

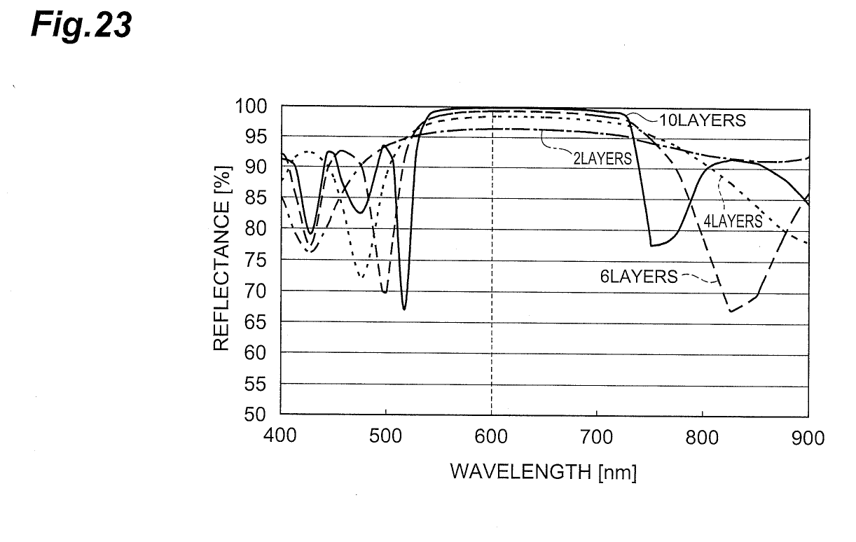

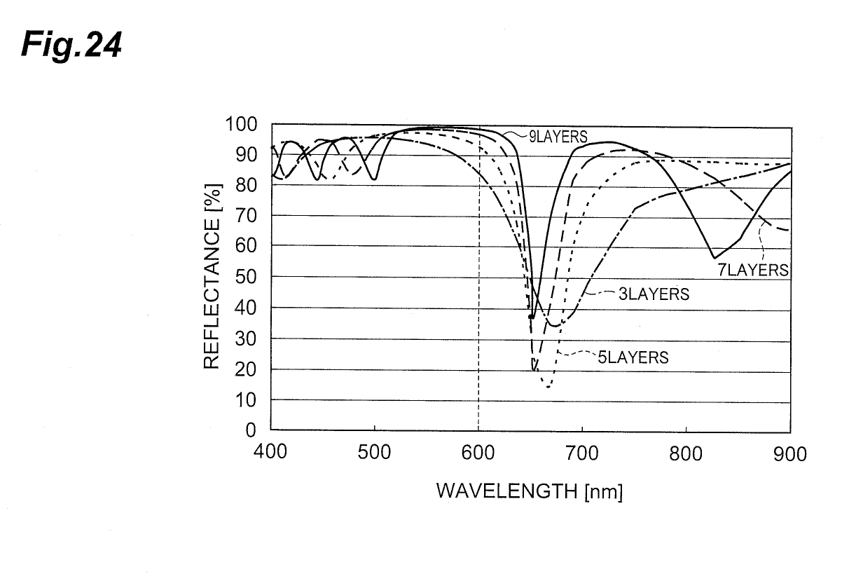

A preferable constituent material of the high refractive index layer is, in addition to TiO₂, Nb₂O₅, Ta₂O₅, HfO₂, or ZrO₂, etc. The refractive index values of these are respectively different, so that the reflectance values of the dielectric multilayer film also differ, however, the same tendency as in the case using TiO₂ is obtained with any material. FIG. 23 and FIG. 24 are graphs showing spectral reflection characteristics of the Nb₂O₅/SiO₂ dielectric multilayer film. FIG. 23 shows a case where a low refractive index layer (SiO₂, optical film thickness 150 [nm]) is disposed as a first layer on the aluminum substrate, and FIG. 24 shows a case where a high refractive index layer (Nb₂O₅, optical film thickness 150 [nm]) is disposed as a first layer on the aluminum substrate. As shown in these figures, even when the constituent material of the high refractive index layer is Nb₂O₅, by forming a low refractive index layer (first layer) first on the metal surface and then laminating a high refractive index layer (second layer) thereon, a sufficient reflectance can be obtained with a number of lamination layers much smaller than in the case where the high refractive index layer is laminated first.

### EXAMPLE 5

### Experimental Proof

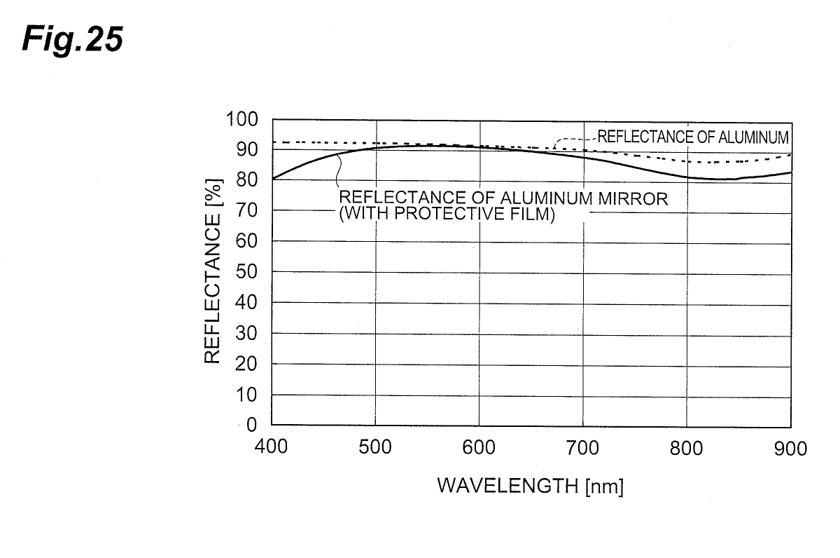

A TiO₂/SiO₂ alternating multilayer film was deposited on a commercially available metal aluminum mirror by vacuum deposition. On the commercially available aluminum mirror, an MgF₂ film with an optical film thickness of 280 [nm] is formed as a protective film. FIG. 25 is a graph showing results of measurement of the spectral reflectance of this aluminum mirror. In addition, in FIG. 25, a calculated value of reflectance of the aluminum surface on which the protective film is not formed is also shown by the dashed line for comparison.

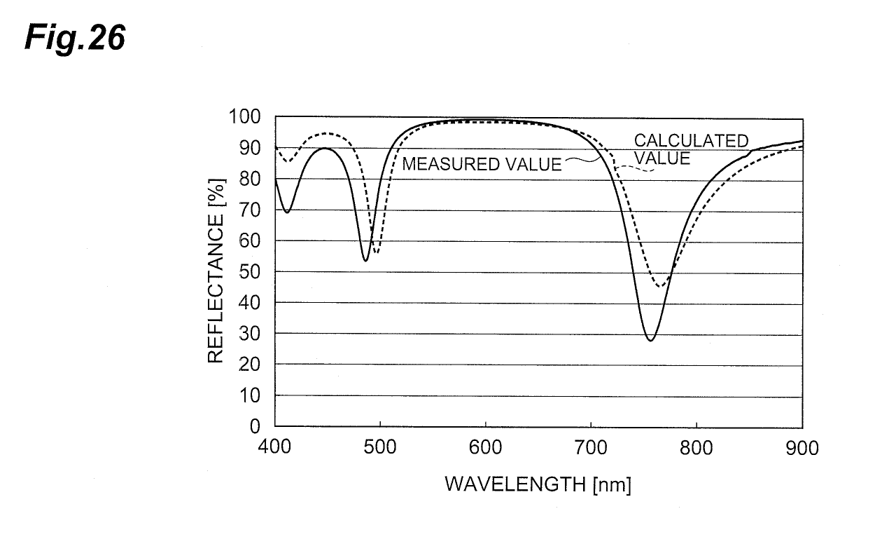

Then, a dielectric multilayer film was formed on the surface of this aluminum mirror. As a lamination configuration, a low refractive index layer (SiO₂, optical film thickness 150 [nm]) is formed as a first layer in contact with the aluminum mirror, and a high refractive index layer (TiO₂, optical film thickness 150 [nm]) and a low refractive index layer (SiO₂, optical film thickness 150 [nm]) were alternately laminated thereon so that the number of lamination layers became 4. The solid line shown in FIG. 26 is a graph showing results of measurement of the reflectance of this dielectric multilayer film. Moreover, the dashed line shown in FIG. 26 is a graph showing results of calculation of the reflectance of this dielectric multilayer film. As shown in FIG. 26, the measured values and calculated values of the reflectance were substantially equal to each other as a result.

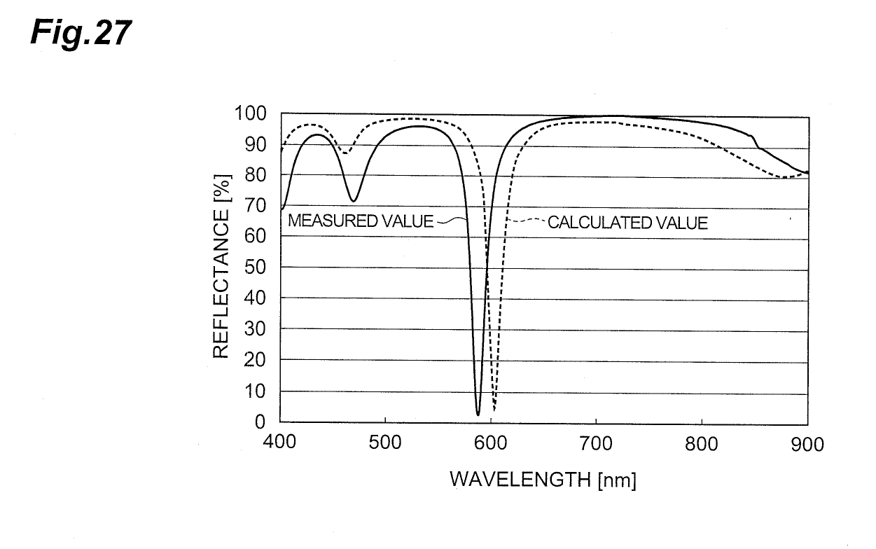

Moreover, as a comparative example, a high refractive index layer (TiO₂, optical film thickness 150 [nm]) is formed as a first layer in contact with the aluminum mirror, and a low refractive index layer (SiO₂, optical film thickness 150 [nm]) and a high refractive index layer (TiO₂, optical film thickness 150 [nm]) were alternately laminated thereon so that the number of lamination layers became 5. The solid line shown in FIG. 27 is a graph showing results of measurement of the reflectance of this dielectric multilayer film. Moreover, the dashed line shown in FIG. 27 is a graph showing results of calculation of the reflectance of this dielectric multilayer film. As shown in FIG. 27, also in this configuration, the measured values and calculated values of the reflectance were substantially equal to each other as a result.

The reflection type light modulation device of the present invention is not limited to the above-described embodiments, and can be modified in many ways. For example, SiO₂ and MgF₂ are shown as examples of constituent materials of the low refractive index layers of the dielectric multilayer film in the embodiments described above, however, as the constituent material of the low refractive index layers, other materials can also be used as long as the materials are dielectric with a refractive index of 1.35 to 1.75, more preferably, 1.35 to 1.50. Further, TiO₂, Nb₂O₅, Ta₂O₅, and HfO₂ are shown as examples of constituent materials of the high refractive index layers of the dielectric multilayer film in the embodiments described above, however, as the constituent material of the high refractive index layers, other materials can also be used as long as the materials are dielectric with a refractive index of 1.75 to 2.50, more preferably, 1.90 to 2.50.

Here, the reflection type light modulation device according to the above-described embodiment modulates light made incident from the front side in each of the plurality of pixels two-dimensionally arrayed and outputs an optical image forward while reflecting the light, and uses a configuration including: a conductive light transmitting layer containing a conductive material which transmits light; a plurality of metallic pixel electrodes two-dimensionally arrayed along the conductive light transmitting layer; a light modulation layer which is disposed between the plurality of pixel electrodes and the conductive light transmitting layer and modulates the light according to an electric field formed by each pixel electrode and the conductive light transmitting layer; and a dielectric multilayer film formed on the plurality of pixel electrodes, wherein the dielectric multilayer film includes a first layer in contact with the pixel electrodes and a second layer having a refractive index higher than that of the first layer and being in contact with the first layer.

Also, the reflection type light modulation device may be configured so that the optical film thickness of the first layer is within the range of ±30% of (λ/4) provided that λ is a wavelength of the light. Alternatively, the reflection type light modulation device may be configured so that the optical film thickness of the first layer is substantially equal to (λ/4)×n (n is an odd number) provided that λ is a wavelength of the light. By using either of these configurations, a high reflectance with respect to light of the predetermined wavelength can be preferably realized.

Moreover, the reflection type light modulation device may be configured so that the optical film thickness of the first layer is within the range of ±30% of (λ/4cosθ) provided that θ is an incident angle of the light inside the first layer and λ is a wavelength of the light. Alternatively, the reflection type light modulation device may be configured so that the optical film thickness of the first layer is substantially equal to (λ/4cosθ)×n (n is an odd number) provided that θ is an incident angle of the light inside the first layer and λ is a wavelength of the light. By using either of these configurations, a high reflectance can be preferably realized with respect to light made incident on the dielectric multilayer film from an oblique direction.

Further, the reflection type light modulation device may be configured so that the dielectric multilayer film is formed by alternately laminating a plurality of low refractive index layers including the first layer and a plurality of high refractive index layers including the second layer and having a refractive index higher than that of the plurality of low refractive index layers, and the sum of the number of layers of the plurality of low refractive index layers and the number of layers of the plurality of high refractive index layers is not more than 10. As described above, a necessary number of lamination layers in the dielectric multilayer film in a general reflection type light modulation device is not less than 13. On the other hand, according to the reflection type light modulation device described above, a sufficiently high reflectance can be realized with a small number of lamination layers of not more than 10, so that lowering of efficiency of electric field application to the light modulation layer can be efficiently suppressed.

Also, the reflection type light modulation device may be configured so that the first layer contains SiO₂, and the second layer contains at least one kind of material among TiO₂, Nb₂O₅, Ta₂O₅, and HfO₂. Accordingly, a dielectric multilayer film including a first layer and a second layer with a refractive index higher than that of the first layer can be preferably configured.

Further, the reflection type light modulation device may be configured so that the first layer includes a lower layer in contact with the pixel electrodes and an upper layer sandwiched between the lower layer and the second layer, the upper layer contains SiO₂, and the lower layer contains at least one kind of material of SiO₂ and MgF₂. On the surfaces of the pixel electrodes, an SiO₂ film or an MgF₂ film is formed as a protective film in some cases, and this protective film may be used as a part (lower layer) of the first layer. Even with this configuration, the effect of the above-described reflection type light modulation device can be preferably obtained.

Alternatively, the reflection type light modulation device modulates light made incident from the front side in each of the plurality of pixels two-dimensionally arrayed and outputs an optical image forward while reflecting the light, and may use a configuration including: a conductive light transmitting layer containing a conductive material which transmits light; a plurality of metallic pixel electrodes two-dimensionally arrayed along the conductive light transmitting layer; a light modulation layer which is disposed between the plurality of pixel electrodes and the conductive light transmitting layer, and modulates the light according to an electric field formed by each pixel electrode and the conductive light transmitting layer; and a dielectric multilayer film formed on the plurality of pixel electrodes, wherein the dielectric multilayer film includes a third layer in contact with the pixel electrodes, a first layer having a refractive index lower than that of the third layer and being in contact with the third layer, and a second layer having a refractive index higher than that of the first layer and being in contact with the first layer, and the optical film thickness of the third layer is substantially equal to (λ/2)×n (n is an odd number) provided that λ is a wavelength of the light.

Industrial Applicability

The present invention is applicable as a reflection type light modulation device capable of increasing light extraction efficiency while suppressing lowering of efficiency of electric field application to a light modulation layer.

1. A reflection type light modulation device which modulates light made incident from the front side in each of a plurality of pixels two-dimensionally arrayed and outputs an optical image forward while reflecting the light, comprising:
a conductive light transmitting layer containing a conductive material which transmits the light;
a plurality of metallic pixel electrodes two-dimensionally arrayed along the conductive light transmitting layer;
a light modulation layer which is disposed between the plurality of pixel electrodes and the conductive light transmitting layer, and modulates the light according to an electric field formed by each pixel electrode and the conductive light transmitting layer; and
a dielectric multilayer film formed on the plurality of pixel electrodes, wherein
the dielectric multilayer film includes:
a first layer in contact with the pixel electrodes; and
a second layer having a refractive index higher than that of the first layer and being in contact with the first layer.

2. The reflection type light modulation device according to claim 1, wherein the optical film thickness of the first layer is within a range of (λ/4)±30% provided that λ, is a wavelength of the light.

3. The reflection type light modulation device according to claim 1, wherein the optical film thickness of the first layer is substantially equal to (λ/4)×n (n is an odd number) provided that λ is a wavelength of the light.

4. The reflection type light modulation device according to claim 1, wherein the optical film thickness of the first layer is within a range of (λ/4cosθ)±30% provided that θ is an incident angle of the light inside the first layer and λ is a wavelength of the light.

5. The reflection type light modulation device according to claim 1, wherein the optical film thickness of the first layer is substantially equal to (λ/4cosθ)×n (n is an odd number) provided that θ is an incident angle of the light inside the first layer and λ is a wavelength of the light.

6. The reflection type light modulation device according to claim 1, wherein
the dielectric multilayer film is formed by alternately laminating a plurality of low refractive index layers including the first layer and a plurality of high refractive index layers including the second layer and having a refractive index higher than that of the plurality of low refractive index layers, and
a sum of the number of layers of the plurality of low refractive index layers and the number of layers of the plurality of high refractive index layers is not more than 10.

7. The reflection type light modulation device according to claim 1, wherein the first layer contains SiO₂, and the second layer contains at least one kind of material among TiO₂, Nb₂O₅, Ta₂O₅, and HfO₂.

8. The reflection type light modulation device according to claim 1, wherein
the first layer includes:
a lower layer in contact with the pixel electrodes; and
an upper layer sandwiched between the lower layer and the second layer,
the upper layer contains SiO₂, and
the lower layer contains at least one kind of material of SiO₂ and MgF₂.

9. A reflection type light modulation device which modulates light made incident from the front side in each of a plurality of pixels two-dimensionally arrayed and outputs an optical image forward while reflecting the light, comprising:
a conductive light transmitting layer containing a conductive material which transmits the light;
a plurality of metallic pixel electrodes two-dimensionally arrayed along the conductive light transmitting layer;
a light modulation layer which is disposed between the plurality of pixel electrodes and the conductive light transmitting layer, and modulates the light according to an electric field formed by each pixel electrode and the conductive light transmitting layer; and
a dielectric multilayer film formed on the plurality of pixel electrodes, wherein
the dielectric multilayer film includes:
a third layer in contact with the pixel electrodes;
a first layer having a refractive index lower than that of the third layer and being in contact with the third layer; and
a second layer having a refractive index higher than that of the first layer and being in contact with the first layer, and
the optical film thickness of the third layer is substantially equal to (λ/2)×n (n is an odd number) provided that λ is a wavelength of the light.
